(19) United States
(12) Patent Application Publication
(10) Pub. No.: US 2021/0123147 A1
(43) Pub. Date: Apr. 29, 2021

(54) PROCESS AND SYSTEM FOR PRODUCING CARBON MONOXIDE AND DIHYDROGEN FROM A CO2-CONTAINING GAS

(71) Applicant: BAIPEM S.P.A., San Donato Milanese (Milano) (IT)

(72) Inventors: Louis Fradette, Québec (CA); Sylvif Fradette, Québec (CA)

(21) Appl. No.: 17/258,966

(22) PCT Filed: Jul. 8, 2019
(86) PCT No.: PCT/CA2019/050940

§ 371 Date: Jan. 8, 2021

Related U.S. Application Data
(60) Provisional application No. 62/696,002, filed on Jul. 10, 2018.

(51) Int. Cl. C25B 1/23; B01D 53/14; B01D 53/86; B01D 53/18; B01D 53/96; C25B 1/50; C25B 1/02; C25B 15/08

(52) U.S. Cl. CPC C25B 1/23; B01D 2257/504; B01D 53/1493; B01D 53/8671; B01D 53/185; B01D 53/1425; B01D 53/8693; B01D 53/965; C25B 1/50; C25B 1/02; C25B 15/08; B01D 2252/10; B01D 2252/602; B01D 2255/804; B01D 53/1475

(57) ABSTRACT

There is provided a process and a system for producing CO and H₂ (syngas) from a CO₂-containing gas. The process includes a step of contacting a CO₂-containing gas with an aqueous absorption solution to produce a bicarbonate loaded stream and a CO₂-depleted gas, followed by a step of subjecting the bicarbonate loaded stream to an electrochemical conversion to generate a gaseous stream including CO and H₂. The system includes an absorption unit wherein the CO₂-containing gas is contacted with the absorption solution to produce the bicarbonate loaded stream and the CO₂-depleted gas and a conversion unit including an electrolytic cell for electrochemically converting bicarbonate ions in the bicarbonate loaded stream into the gaseous stream including CO and H₂ and a bicarbonate depleted stream. In some embodiments, an enzyme such as a carbonic anhydrase can be used to catalyze the conversion of the CO₂-containing gas into the bicarbonate loaded stream.

### RELATED APPLICATION

This application claims priority to U.S. provisional application No. 62/696.002 filed on Jul. 10, 2018, the content of which is incorporated herein by reference in its entirety for all purposes.

### TECHNICAL FIELD

The technical field generally relates to processes and systems for the production of carbon monoxide (CO) and dihydrogen (H₂). More particularly, the processes and systems allow for the production of CO and H₂ from bicarbonate ions formed by capturing CO₂ contained in gases that are produced by various industrial processes, such as flue gas or a process gas.

### BACKGROUND

Production of CO and H₂ mixtures, also referred to as “synthesis gas” or simply “syngas”, commonly involves heating carbon-based materials, such as fossil fuels (e.g., coal) or organics (e.g., biomass) at extremely high temperatures in the presence of a controlled amount of oxygen or steam. For instance, the formation of syngas can be performed by steam reforming of natural gas (or shale gas) which proceeds in tubular reactors that are heated externally. The reaction is strongly endothermic and requires elevated temperatures. The process uses nickel catalyst on a special support that is resistant against the harsh process conditions. Alternative routes to syngas, can involve the reduction of CO₂ from flue gas with H₂ from electrolytic splitting of water.

Electrochemical reduction of CO₂ is another method to produce CO and H₂. The method involves supplying electricity to an electrochemical cell containing an aqueous solution containing dissolved CO₂. The reduction of CO₂ into CO occurs on the cathode and it is balanced by the electrolytic dissociation of water on the anode supplying the protons needed to hydrogenate CO₂ through a proton exchange membrane. The reactions that occur at the cathode are as follows:

CO₂+2H⁺+2e⁻⇄CO+H₂O

2H⁺+2e⁻⇄H₂

An intrinsic limitation to the electrochemical reduction of CO₂ is the low solubility of CO₂ in water. In aqueous electrolytes used in electrochemical reduction the CO₂ solubility is even lower, due to the high ionic strength. Moreover, providing a pure or substantially pure CO₂ stream requires pre-concentration of CO₂ containing feedstocks. Different conventional technologies can be used for this purpose, such as adsorption or absorption. In these technologies, CO₂ from a flue gas for instance is first removed from the gas phase and stored in a solid phase (adsorption) or in a liquid phase (chemical absorption) and, in a second step, the CO₂ is released in a highly concentrated gaseous form when the solid or liquid phase is regenerated following heating of medium and/or pressure decrease. However, capital and operation costs associated with these technologies are high, which result in a significant increase of the overall production cost.

There is a need for a technology to produce CO and H₂ mixtures (syngas) which would allow directly using CO₂-containing gas, without requiring to release purified gaseous CO₂ before electrochemical conversion of the CO₂ into CO and H₂.

### SUMMARY

Processes and systems are provided to produce carbon monoxide (CO) and dihydrogen (H₂), or syngas, from a CO₂-containing gas. The processes can involve absorption of CO₂ from a CO₂-containing gas and electrochemical conversion of bicarbonate resulting from the absorption into CO and H₂.

According to one aspect, there is provided a process for producing carbon monoxide (CO) and dihydrogen (H₂) from a CO₂-containing gas, the process comprising:

contacting a CO₂-containing gas with an aqueous absorption solution to produce a bicarbonate loaded stream and a CO₂-depleted gas; and subjecting the bicarbonate loaded stream to an electrochemical conversion to generate a gaseous stream comprising CO and H₂.

In some implementations of the process, the aqueous absorption solution can comprise an absorption compound selected from the group consisting of sterically hindered amines, sterically hindered alkanolamines, tertiary amines, tertiary alkanolamines, tertiary amino acids and carbonates or any mixture thereof.

In some implementations of the process, the aqueous absorption solution can comprise an absorption compound selected from the group consisting of 2-amino-2-methyl-1-propanol (AMP), 2-amino-2-hydroxymethyl-1,3-propenediol (Tris), N-methyldiethanolamine (MDEA), dimethylmonoethanolamine (DMMEA), diethylmonoethanolamine (DEMEA), triisopropanolamine (TIPA), triethanolamine, N-methyl N-secondary butyl glycine, diethylglycine, dimethylglycine, potassium carbonate, sodium carbonate, cesium carbonate and any mixture thereof.

In some implementations of the process, the aqueous absorption solution can comprise an absorption compound selected from the group consisting of sodium carbonate, potassium carbonate, cesium carbonate and any mixture thereof.

In some implementations of the process, the aqueous absorption solution can comprise an absorption compound selected from the group consisting of sodium carbonate and potassium carbonate, or any mixture thereof.

In some implementations of the process, the aqueous absorption solution can comprise a promotor and/or a catalyst.

In some implementations of the process, the aqueous absorption solution can comprise a promotor and/or a catalyst selected from the group consisting of piperazine, diethanolamine (DEA), diisopropanolamine (DIPA), methylaminopropylamine (MAPA), 3-aminopropanol (AP), 2,2-dimethyl-1,3-propanediamine (DMPDA), diglycolamine (DGA), 2-amino-2-methylpropanol (AMP), 1-amino-2-propanol (MIPA), 2-methyl-methanolamine (MMEA), piperidine (PE), arsenite, hypochlorite, sulphite, glycine, sarcosine, alanine N-secondary butyl glycine, pipecolinic acid and a carbonic anhydrase or an analogue thereof, or any mixture thereof.

In some implementations of the process, the aqueous absorption solution can comprise a promotor and/or a catalyst selected from the group consisting of glycine, sarcosine, alanine N-secondary butyl glycine, pipecolinic acid and a carbonic anhydrase or an analogue thereof.

In some implementations of the process, the aqueous absorption solution can comprise a promotor and/or a catalyst being a carbonic anhydrase or an analogue thereof.

In some implementations of the process, the aqueous absorption solution can comprise sodium and/or potassium carbonate and a carbonic anhydrase or an analogue thereof.

In some implementations of the process, the carbonic anhydrase or the analogue thereof can be present in the aqueous absorption solution in a concentration that is equal or less than 1% by weight of the absorption solution.

In some implementations of the process, the carbonic anhydrase or the analogue thereof can be present in the aqueous absorption solution in a concentration of up to 10 g/l.

In some implementations of the process, the carbonic anhydrase or the analogue thereof can be present in the aqueous absorption solution in a concentration ranging from 0.05 to 2 g/l.

In some implementations of the process, the carbonic anhydrase or the analogue thereof can be present in the aqueous absorption solution in a concentration ranging from 0.1 to 0.5 g/l.

In some implementations of the process, the carbonic anhydrase or the analogue thereof can be present in the aqueous absorption solution in a concentration ranging from 0.15 to 0.3 g/l.

In some implementations of the process, the carbonic anhydrase or the analogue thereof can be separated from the bicarbonate loaded stream before subjecting the bicarbonate loaded stream to the electrochemical conversion to generate CO and H₂.

In some implementations, the process can further comprise recycling the carbonic anhydrase or the analogue thereof to the aqueous absorption solution.

In some implementations of the process, the aqueous absorption solution can comprise sodium carbonate and a concentration in sodium in the absorption solution ranges from 0.5 to 2 mol/l.

In some implementations of the process, the aqueous absorption solution can comprise potassium carbonate and a concentration in potassium in the absorption solution ranges from 1 to 6 mol/l.

In some implementations of the process, the aqueous absorption solution comprises potassium carbonate and potassium bicarbonate, and a CO₂ loading in the absorption solution, before contacting the CO₂-containing gas, can range from 0.5 to 0.75 mol C/mol K+.

In some implementations of the process, the bicarbonate loaded stream comprises potassium bicarbonate and potassium carbonate, and a CO₂ loading in the bicarbonate loaded stream, after contacting the CO₂-containing gas, can range from 0.75 to 1 mol C/mol K+.

In some implementations of the process, the aqueous absorption solution comprises a carbonic anhydrase or an analogue thereof, and a pH of the aqueous absorption solution can range from 8.5 to 10.5.

In some implementations of the process, the CO₂-containing gas can be contacted with the aqueous absorption solution in a packed column, a spray absorber, a fluidized bed or a high intensity contactor, such as rotating packed bed.

In some implementations of the process, the CO₂-containing gas can be contacted with the aqueous absorption solution comprising a carbonic anhydrase or an analogue thereof as catalyst, at a temperature ranging from about 5° C. to about 70° C., preferably from about 20° C. to about 70° C., more preferably from about 25° C. to about 60° C.

In some implementations of the process, the electrochemical conversion can comprise converting bicarbonate ions of the bicarbonate loaded stream into the gaseous stream comprising CO and H₂ in an electrolytic cell provided with an alkaline electrolyte solution and generating a bicarbonate depleted stream.

In some implementations of the process, the bicarbonate depleted stream can be recycled to the aqueous absorption solution for contacting with the CO₂-containing gas.

In some implementations of the process, the conversion of the bicarbonate ions into CO and H₂ can be conducted at a cathode compartment of the electrolytic cell.

In some implementations of the process, the alkaline electrolyte solution can be provided at an anode compartment of the electrolytic cell and the conversion of the bicarbonate ions into CO and H₂ can be conducted at a cathode compartment of the electrolytic cell.

In some implementations of the process, the alkaline electrolyte solution can comprise an aqueous solution of KOH or NaOH.

In some implementations of the process, the alkaline electrolyte solution can comprise KOH or NaOH in a concentration ranging from 0.5 to 10 mol/l.

In some implementations of the process, the electrochemical conversion can be conducted at a temperature ranging from 20 to 70° C.

In some implementations of the process, the electrochemical conversion can be conducted at a current density ranging from 20 to 200 mA.cm⁻².

In some implementations of the process, the electrochemical conversion can be conducted at a current density ranging from 100 to 200 mA.cm⁻².

In some implementations of the process, the electrochemical conversion can be conducted at a current density ranging from 150 to 200 mA.cm⁻².

According to another aspect, there is also provided a system for producing carbon monoxide (CO) and dihydrogen (H₂) from a CO₂-containing gas, the system comprising:
an absorption unit for contacting a CO₂-containing gas with an aqueous absorption solution to produce a bicarbonate loaded stream; and
a conversion unit comprising an electrolytic cell for electrochemically converting bicarbonate ions in the bicarbonate loaded stream to generate a gaseous stream comprising CO and H₂ and a bicarbonate depleted stream.

In some implementations of the system, the aqueous absorption solution can comprise an absorption compound selected from the group consisting of sterically hindered amines, sterically hindered alkanolamines, tertiary amines, tertiary alkanolamines, tertiary amino acids and carbonates or any mixture thereof.

In some implementations of the system, the aqueous absorption solution can comprise an absorption compound selected from the group consisting of 2-amino-2-methyl-1-propanol (AMP), 2-amino-2-hydroxymethyl-1,3-propenediol (Tris), N-methyldiethanolamine (MDEA), dimethylmonoethanolamine (DMMEA), diethylmonoethanolamine (DEMEA), triisopropanolamine (TIPA), triethanolamine, N-methyl N-secondary butyl glycine, diethylglycine, dimethylglycine, potassium carbonate, sodium carbonate, cesium carbonate and any mixture thereof.

In some implementations of the system, the aqueous absorption solution can comprise an absorption compound selected from the group consisting of sodium carbonate, potassium carbonate, cesium carbonate and any mixture thereof.

In some implementations of the system, the aqueous absorption solution can comprise an absorption compound selected from the group consisting of sodium carbonate and potassium carbonate, or any mixture thereof.

In some implementations of the system, the aqueous absorption solution can comprise a promotor and/or a catalyst.

In some implementations of the system, the aqueous absorption solution can comprise a promotor and/or a catalyst selected from the group consisting of piperazine, diethanolamine (DEA), diisopropanolamine (DIPA), methylaminopropylamine (MAPA), 3-aminopropanol (AP), 2,2-dimethyl-1,3-propanediamine (DMPDA), diglycolamine (DGA), 2-amino-2-methylpropanol (AMP), 1-amino-2-propanol (MIPA), 2-methyl-methanolamine (MMEA), piperidine (PE), arsenite, hypochlorite, sulphite, glycine, sarcosine, alanine N-secondary butyl glycine, pipecolinic acid and a carbonic anhydrase or an analogue thereof, or any mixture thereof.

In some implementations of the system, the aqueous absorption solution can comprise a promotor and/or a catalyst selected from the group consisting of glycine, sarcosine, alanine N-secondary butyl glycine, pipecolinic acid and a carbonic anhydrase or an analogue thereof.

In some implementations of the system, the aqueous absorption solution can comprise a promotor and/or a catalyst being a carbonic anhydrase or an analogue thereof.

In some implementations of the process, the aqueous absorption solution can comprise sodium and/or potassium carbonate and a carbonic anhydrase or an analogue thereof.

In some implementations of the system, the carbonic anhydrase or the analogue thereof can be present in the aqueous absorption solution in a concentration that is equal or less than 1% by weight of the absorption solution.

In some implementations of the system, the carbonic anhydrase or the analogue thereof can be present in the aqueous absorption solution in a concentration of up to 10 g/l.

In some implementations of the system, the carbonic anhydrase or the analogue thereof can be present in the aqueous absorption solution in a concentration ranging from 0.05 to 2 g/l.

In some implementations of the system, the carbonic anhydrase or the analogue thereof can be present in the aqueous absorption solution in a concentration ranging from 0.1 to 0.5 g/l.

In some implementations of the system, the carbonic anhydrase or the analogue thereof can be present in the aqueous absorption solution in a concentration ranging from 0.15 to 0.3 g/l.

In some implementations, the system can further comprise a separating unit downstream the absorption unit and upstream the conversion unit to separate the carbonic anhydrase or the analogue thereof from the bicarbonate loaded stream.

In some implementations, the system can further comprise an enzyme recycling line for returning the separated carbonic anhydrase or the analogue thereof to the absorption unit.

In some implementations of the system, the aqueous absorption solution can comprise sodium carbonate and a concentration in sodium in the absorption solution ranges from 0.5 to 2 mol/l.

In some implementations of the system, the aqueous absorption solution can comprise potassium carbonate and a concentration in potassium in the absorption solution ranges from 1 to 6 mol/l.

In some implementations of the system, the aqueous absorption solution comprises potassium carbonate and potassium bicarbonate and a CO₂ loading of the absorption solution entering the absorption unit can range from 0.5 to 0.75 mol C/mol K+.

In some implementations of the system, the bicarbonate loaded stream comprises potassium bicarbonate and potassium carbonate and a CO₂ loading of the bicarbonate loaded stream exiting the absorption unit can range from 0.75 to 1 mol C/mol K+.

In some implementations of the system, the aqueous absorption solution comprises a carbonic anhydrase or an analogue thereof, and a pH of the aqueous absorption solution can range from 8.5 to 10.5.

In some implementations of the system, the absorption unit can comprise a packed column, a spray absorber, a fluidized bed or a high intensity contactor, such as rotating packed bed.

In some implementations of the system, the aqueous absorption solution comprises a carbonic anhydrase or an analogue thereof as catalyst and a contacting temperature in the absorption unit can range from about 5° C. to about 70° C., preferably from about 20° C. to about 70° C., more preferably from about 25° C. to about 60° C.

In some implementations of the system, the electrolytic cell can comprise an anode compartment and a cathode compartment, wherein an alkaline electrolyte solution is allowed to flow through the anode compartment and wherein converting the bicarbonate ions of the bicarbonate loaded stream into the gas stream comprising CO and H₂ is conducted in the cathode compartment.

In some implementations of the system, the alkaline electrolyte solution can comprise an aqueous solution of KOH or NaOH.

In some implementations of the system, the alkaline electrolyte solution can comprise KOH or NaOH in a concentration ranging from 0.5 to 10 mol/l.

In some implementations the system can further comprise a return line for recycling the bicarbonate depleted stream to the absorption unit.

In some implementations of the system, the conversion temperature in the electrolytic cell can range from 20 to 70 ° C.

In some implementations of the system, the current density applied to the electrolytic cell can range from 20 to 200 mA.cm⁻².

In some implementations of the system, the current density applied to the electrolytic cell can range from 100 to 200 mA.cm⁻².

In some implementations of the system, the current density applied to the electrolytic cell can range from 150 to 200 mA.cm⁻².

It should be noted that any of the features described above and/or herein can be combined with any other features, processes and/or systems described herein, unless such features would be clearly incompatible.

### BRIEF DESCRIPTION OF THE DRAWINGS

FIG. 1 is a process flow diagram representing a process for producing a gaseous stream comprising CO and H₂ according to one embodiment. This embodiment involves a CO₂ absorption to produce bicarbonate ions followed by an electrochemical conversion of the bicarbonate ions into CO and H₂.

FIG. 2 is a process flow diagram representing a process for producing a gaseous stream comprising CO and H₂ according to another embodiment. This embodiment involves a CO₂ absorption to produce bicarbonate ions followed by an electrochemical conversion of the bicarbonate ions into CO and H₂, where the CO₂ absorption is conducted in the presence of an enzyme and an enzyme separation step is provided in the process.

FIG. 3 is a schematic representation of the reactions involved at an electrolytic cell that can be used for the electrochemical conversion of the bicarbonate ions into CO and H₂ according to one embodiment of the process.

FIG. 4 represents the Faradaic efficiency in function of the current density determined for the electrolytic conversion of bicarbonate ions to CO and H₂ in the presence of an enzyme in the bicarbonate solution.

FIG. 5 represents the Faradaic efficiency in function of the current density determined for the electrolytic conversion of bicarbonate ions to CO and H₂ using two different bicarbonate solutions: Solution 1 being exempt of enzyme and Solution 2 containing an enzyme.

### DETAILED DESCRIPTION

The present process and system are provided for producing carbon monoxide (CO) and dihydrogen (H₂) as a mixture, from a CO₂-containing gas, by contacting the CO₂-containing gas with an aqueous absorption solution in order to produce a bicarbonate loaded stream, and then subjecting the bicarbonate loaded stream to an electrochemical conversion to generate a gaseous stream comprising CO and H₂. Gaseous mixtures comprising CO and H₂ are also known as “syngas” and are useful intermediate resource for production of hydrogen, ammonia, methanol and other synthetic hydrocarbon fuels.

As will be apparent in the following detailed description, the present process and system permit production of the mixture of CO and H₂ from a CO₂-containing gas, without requiring a step of isolating high concentrated (substantially pure) CO₂ gas before the electrochemical conversion, as required in prior art processes.

According to some embodiments, the CO₂-containing gas can be a power and/or steam plant flue gas, an industrial exhaust gas, or a chemical production flue gas. In some embodiments, the CO₂-containing gas can be a flue gas from a coal power and/or steam station, a flue gas from a gas power and/or steam station, a flue gas from metals production, a flue gas from a cement plant, a flue gas from a pulp and paper mill, an emission from lime kilns, a flue gas from a bicarbonate unit or a flue gas from a soda ash mill.

Embodiments of the process and system for the production of CO and H₂ from a CO₂-containing gas will now be described referring to the Figures. The process involves two main steps which can be performed in two main units: a CO₂ capture unit (10) also named “absorption unit” and a bicarbonate conversion unit (12) enabling the production of CO and H₂. In the following description, the bicarbonate conversion unit (12) will also be referred to as “electrochemical conversion unit” or simply “conversion unit”, these expressions being used interchangeably.

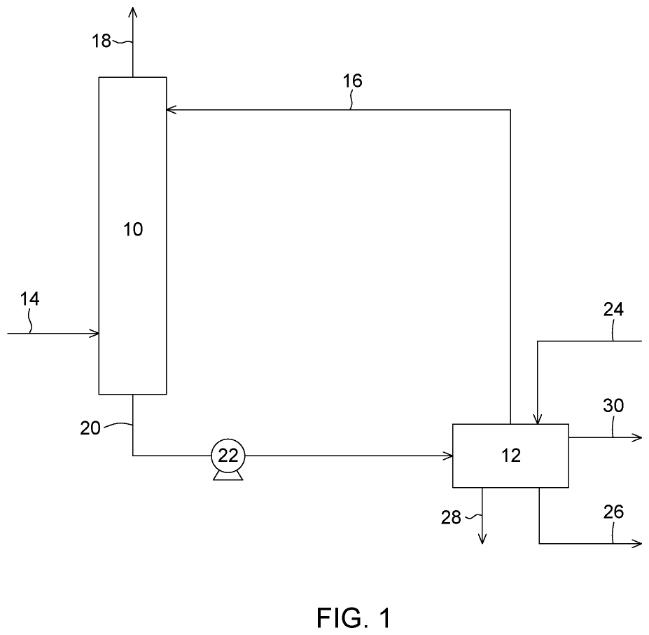

A first embodiment is represented in FIG. 1. The CO₂ capture unit or absorption unit (10) can be a gas/liquid contactor where the CO₂-containing gas (14) can be contacted with an aqueous absorption solution (16). Upon contacting the CO₂-containing gas with the absorption solution, the CO₂ is dissolved or absorbed in the aqueous absorption solution and then transformed, at least partially, into bicarbonate ions (HCO₃⁻). In the absorption solution, the CO₂ from the CO₂-containing gas is thus subjected to a hydration reaction resulting in the formation of the bicarbonate ions in solution. A CO₂-depleted gas (18) can then leave the absorption unit (10) and can be released to the atmosphere or used for other purposes. The aqueous absorption solution containing the bicarbonate ions (20) can then be pumped through a pump (22) towards the conversion unit (12). The conversion unit (12) comprises an electrolytic cell, which can be fed with an alkaline electrolyte solution flowing in (24) and out (26) of the electrolytic cell. In the electrolytic cell, the bicarbonate ions present in the bicarbonate loaded aqueous solution (20) can be transformed into a gaseous stream comprising CO and H₂ (28). Oxygen gas (30) is also generated during the electrolytic conversion. A bicarbonate depleted stream produced through the electrochemical conversion of the bicarbonate loaded stream in the electrolytic cell, thus having a reduced bicarbonate ion concentration, can be recovered. In one embodiment, the bicarbonate depleted stream can be recycled as the absorption solution to be fed to the absorption unit (10). The gaseous mixture of CO and H₂ or syngas (28) can be used for further chemical transformation reactions.

It is worth noting that stream (16) recycled to the absorption unit (10) can comprise some bicarbonate ions and can comprise carbonate ions from the initial absorption solution. Hence, in a continuous process, stream (20) and stream (16) can both comprise carbonate and bicarbonate ions. In some embodiments, if necessary, additional carbonate absorption compound can be added to stream (16) before it enters the absorption unit (10) (not shown in the Figures).

In some embodiments, the absorption unit (10) in which the CO₂-containing gas is contacted with the aqueous solution for hydration of the CO₂ into bicarbonate ions can be a gas/liquid contactor comprising a packed column, a spray absorber, a fluidized bed or a high intensity contactor, such as rotating packed bed.

The absorption solution used for contacting the CO₂-containing gas in the absorption unit comprises water and at least one absorption compound. The absorption compounds can be selected to promote the transformation of CO₂ into bicarbonate ions in the absorption solution. In some embodiments, the absorption compounds can be from the class of sterically hindered amines, sterically hindered alkanolamines, tertiary amines, tertiary alkanolamines, tertiary amino acids or carbonates. These compounds present a common property which is that they do not form carbamate-amine complexes when CO₂ is absorbed in solutions comprising such components. In some embodiments, the aqueous absorption solution can comprise a mixture of the above-mentioned absorption compounds.

In some embodiments, the absorption compound can comprise 2-amino-2-methyl-1-propanol (AMP), 2-amino-2-hydroxymethyl-1,3-propenediol (Tris), N-methyldiethanolamine (MDEA), dimethylmonoethanolamine (DMMEA), diethylmonoethanolamine (DEMEA), triisopropanolamine (TIPA), triethanolamine, N-methyl N-secondary butyl glycine, diethylglycine, dimethylglycine, potassium carbonate, sodium carbonate, cesium carbonate, or any mixtures thereof.

In particular embodiments, the absorption compound can be selected from sodium carbonate, potassium carbonate, cesium carbonate, or any mixture thereof. In preferred embodiments, sodium carbonate, potassium carbonate or their mixture can be used as absorption compounds in the aqueous absorption solution.

In some embodiments, stream (16) entering the absorption unit (10) can comprise sodium or potassium bicarbonate and carbonate ions in a bicarbonate/carbonate ratio (mol/mol) which can range from 0.5 to 2. In some embodiments, the sodium or potassium bicarbonate/carbonate ratio (mol/mol) of stream (16) entering the absorption unit (10) can range from 0.5 to 1.8, or from 0.5 to 1.5, or from 0.5 to 1, or from 0.7 to 2, or from 1 to 2, or from 1.2 to 2 or from 1.5 to 2. After absorption of the CO₂ in the absorption unit, the concentration of bicarbonate ions is increased and the bicarbonate/carbonate ratio in the stream exiting the absorption unit is also increased. Therefore, the bicarbonate/carbonate ratio in the stream sent to the conversion unit (12) is higher than the bicarbonate/carbonate ratio entering the absorption unit (10). In some embodiments, the stream entering the conversion unit (12) can comprise sodium or potassium bicarbonate and carbonate ions in a bicarbonate/carbonate ratio (mol/mol) which can range from 3 to 18. In some embodiments, the sodium or potassium bicarbonate/carbonate ratio (mol/mol) in the stream entering the conversion unit (12) can range from 3 to 15, or from 3 to 10, or from 3 to 5, or from 5 to 18, or from 5 to 15, or from 5 to 10, or from 10 to 18, or from 10 to 15, or from 15 to 18. Upon conversion of the bicarbonate ions in the conversion unit, where the bicarbonate ions are converted into CO and H₂, the bicarbonate/carbonate ratio is then reduced and, in some embodiments, the stream exiting the conversion unit can present a bicarbonate/carbonate ratio which can be close or substantially similar to the bicarbonate/carbonate ratio in the initial stream (16) which was treated in the absorption unit. For example, if stream (16) contained bicarbonate/carbonate ions in a ratio of 1 and that after absorption of the CO₂ in the absorption unit, the ratio in stream (20) is 8, one can expect, in some embodiments, to return to a ratio of 1, or close to 1, at the exit of the conversion unit once the bicarbonate ions have been converted into CO and H₂.

In some embodiments, the aqueous absorption solution can also comprise at least one absorption promoter and/or catalyst, in addition to the absorption compound, to increase the CO₂ absorption rate into the absorption solution. The catalyst can be a biocatalyst, for instance an enzyme.

Examples of promoters, catalysts or biocatalysts can comprise piperazine, diethanolamine (DEA), diisopropanolamine (DIPA),methylaminopropylamine (MAPA), 3-aminopropanol (AP), 2,2-dimethyl-1,3-propanediamine (DMPDA), diglycolamine (DGA), 2-amino-2-methylpropanol (AMP), 1-amino-2-propanol (MIPA), 2-methyl-methanolamine (MMEA), piperidine (PE), arsenite, hypochlorite, sulphite, glycine, sarcosine, alanine N-secondary butyl glycine, pipecolinic acid, the enzyme carbonic anhydrase, or any mixture thereof. In some embodiments, the aqueous absorption solution can comprise a promotor and/or a catalyst selected from glycine, sarcosine, alanine N-secondary butyl glycine, pipecolinic acid and a carbonic anhydrase or an analogue thereof. In preferred embodiments, carbonic anhydrase or an analogue thereof can be used as catalyst for enhancing the absorption of CO₂ in the aqueous solution.

In some embodiments, the CO₂-containing gas can be contacted in the absorption unit with an aqueous absorption solution comprising sodium and/or potassium carbonate and a carbonic anhydrase or an analogue thereof. In another embodiments, the CO₂-containing gas can be contacted in the absorption unit with an aqueous absorption solution comprising sodium and/or potassium carbonate in the presence of a carbonic anhydrase or an analogue thereof which is immobilized within the absorption reactor itself. In other words, the carbonic anhydrase or analogue thereof can be either present in the absorption solution and flow with the absorption solution or can be immobilized within the absorption reactor (e.g., on packing). When the carbonic anhydrase or analogue thereof is present in the absorption solution it can be free and dissolved in solution or it can be supported on or in particles that flow with the solution.

In a particular embodiment, the absorption solution used to capture CO₂ can be an aqueous potassium carbonate containing solution which also contains a carbonic anhydrase (CA) or an analogue thereof (either free or supported). Under such a process configuration, the CO₂-containing gas can be fed to the absorption unit (10) wherein the CO₂ present in the gas can dissolve in the potassium carbonate solution containing the carbonic anhydrase or analogue thereof and can then react with the hydroxide ions (Equation 1) and water (Equations 2 and 3). The carbonic anhydrase-catalyzed CO₂ hydration reaction (Equation 3) is the dominant reaction in the process.

CO₂+OH⁻→HCO₃⁻ Equation 1

CO₂+H₂O→H₂CO₃→HCO₃⁻+H⁺ Equation 2

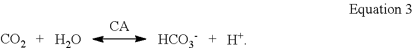

The carbonic anhydrase which can be used to enhance CO₂ capture, may be from human, bacterial, fungal or other organism origins, having thermostable or other stability properties, as long as the carbonic anhydrase or analogue thereof can catalyze the hydration of the carbon dioxide to form hydrogen and bicarbonate. It should also be noted that “carbonic anhydrase or an analogue thereof” as used herein includes naturally occurring, modified, recombinant and/or synthetic enzymes including chemically modified enzymes, enzyme aggregates, cross-linked enzymes, enzyme particles, enzyme-polymer complexes, polypeptide fragments, enzyme-like chemicals such as small molecules mimicking the active site of carbonic anhydrase enzymes and any other functional analogue of the enzyme carbonic anhydrase.

The enzyme carbonic anhydrase can have a molecular weight up to about 104,000 daltons. In some embodiments, the carbonic anhydrase can be of relatively low molecular weight (e.g., 30,000 daltons).

The term “about”, as used herein before any numerical value, means within an acceptable error range for the particular value as determined by one of ordinary skill in the art. This error range may depend in part on how the value is measured or determined, i.e. the limitations of the measurement system. It is commonly accepted that a 10% precision measure is acceptable and encompasses the term “about”.

The carbonic anhydrase or analogue thereof can be provided in various ways in the absorption solution, in addition to being provided free and dissolved in solution. It can be supported on or in particles that flow with the solution, directly bonded to the surface of particles, entrapped inside or fixed to a porous support material matrix, entrapped inside or fixed to a porous coating material that is provided around a support particle that is itself porous or non-porous, or present as crosslinked enzyme aggregates (CLEA) or crosslinked enzyme crystals (CLEC). When the carbonic anhydrase or analogue thereof is used in association with particles that flow in solution, the enzymatic particles can be prepared by various immobilization techniques and then deployed in the system. When the carbonic anhydrase or analogue thereof is used in non-immobilized for (e.g., free in solution), it can be added in powder form, enzyme-solution form, enzyme-suspension form or enzyme-dispersion form, into the absorption solution where it can become a soluble part of the absorption solution.

Still referring to FIG. 1, after absorption and hydration of the CO₂ gas has been completed, the absorption solution loaded with bicarbonate ions (20) can leave the absorption unit (10) and be fed to the conversion unit (12) for the electrolytic production of CO and H₂. If the carbonic anhydrase enzyme is present in the bicarbonate loaded stream (20), the carbonic anhydrase will thus flow through the electrolytic cell. As explained above, the bicarbonate ions of the bicarbonate loaded stream (20) will then be converted electrochemically in the electrolytic cell into a mixture of CO and H₂ gas, and a stream (16) depleted in bicarbonate ions and containing the carbonic anhydrase will then be pumped back to the gas/liquid absorption unit (10). Therefore, in the configuration represented in FIG. 1, the carbonic anhydrase can be recycled to the absorption unit directly from the electrochemical conversion unit through the bicarbonate depleted stream which is returned as the aqueous absorption solution to the absorption step.

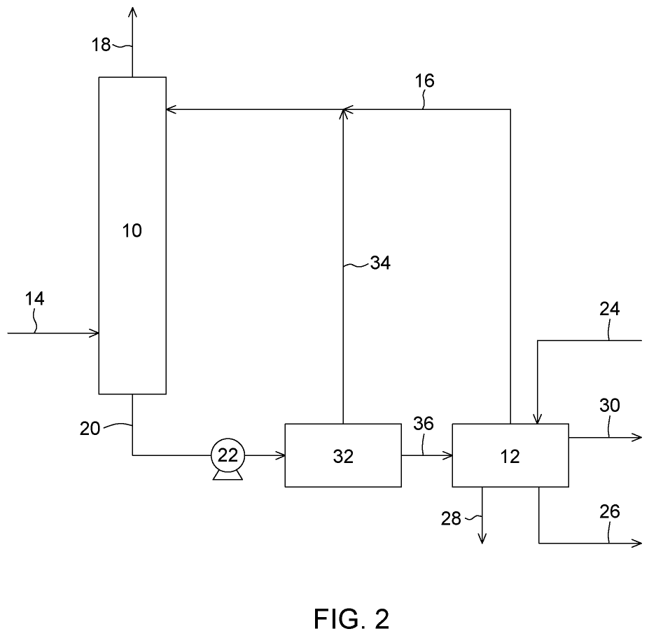

In another configuration, according to the embodiment represented in FIG. 2, the absorption of CO₂ from the CO₂-containing gas is conducted in the absorption unit (10) in the presence of carbonic anhydrase or an analogue thereof which is present in the absorption solution either free or immobilized in or on particles. In this embodiment, the carbonic anhydrase or analogue thereof can be removed from the bicarbonate loaded stream (20) produced in the absorption unit (10) prior the bicarbonate loaded stream (20) can be treated in the conversion unit (12). Therefore, in this process configuration, the solution containing the bicarbonate ions (20) can be pumped through the pump (22) and sent to a separation unit (32). In the separation unit (32), the carbonic anhydrase or analogue thereof can be separated from the bicarbonate loaded stream (20) and recovered. In some embodiments, the separated carbonic anhydrase or analogue thereof (34) can be directly recycled in the process by mixing with the bicarbonate depleted stream (16) leaving the conversion unit (12). Then, the mixture of the bicarbonate depleted stream (16) and separated carbonic anhydrase or analogue thereof (34) can be sent back to the gas/liquid absorption unit (10). Depending on how the enzyme is delivered in the absorption solution, i.e. free in solution or attached to a particle or entrapped into a particle, the separation unit (32) might differ. In some embodiments, the separation unit (32) can be a settler, a filter, a membrane, a cyclone, or any other unit known in the art to remove molecules or particles of the size to be used in the process.

In some embodiments of the process, when the carbonic anhydrase or analogue thereof is used to promote CO₂ hydration, the carbonic anhydrase or analogue thereof can be provided in a concentration below 1% by weight of the absorption solution. When the enzyme is provided in the absorption solution, its concentration in the solution can be up to about 10 g/l. In some embodiments, the enzyme concentration can range from 0.05 to 10 g/l, or from 0.05 to 5 g/l, or from 0.05 to 2 g/l, or from 0.1 to 10 g/l, or from 0.1 to 5 g/l, or from 0.1 to 2 g/l, or from 0.1 to 1 g/l, or from 0.1 to 0.5 g/l, or from 0.15 to 10 g/l, or from 0.15 to 5 g/l, or from 0.15 to 2 g/l, or from 0.15 to 1 g/l, or from 0.15 to 0.5 g/l, or from 0.15 to 0.3 g/l. In particular embodiments, the enzyme concentration can range from 0.05 to 2 g/l, or from 0.1 to 0.5 g/l, or from 0.15 to 0.3 g/l. In other examples, the concentration in carbonic anhydrase or analogue thereof can be above this value, depending on various factors such as process design, enzyme activity and enzyme stability.

In some embodiments, the concentration of the absorption compound of the absorption solution can be determined to minimise the solution circulation flow rate, maximise the bicarbonate ion concentration in the solution while limiting bicarbonate precipitation, and minimising the enzyme carbonic anhydrase cost.

When the absorption compound is sodium carbonate, the sodium carbonate solution can have a sodium concentration ranging from 0.5 to 2 mol/l. In some embodiments, the sodium carbonate absorption solution can have a sodium concentration ranging from 0.5 to 1.5 mol/l, or from 0.5 to 1 mol/l, or from 1 to 2 mol/l, or from 1 to 1.5 mol/l, or from 1.5 to 2 mol/l. The CO₂ loading of the absorption solution entering the gas/liquid absorption unit can range from 0.5 to 0.75 mol C/mol Nat, or from 0.5 to 0.7 mol C/mol Nat, or from 0.6 to 0.7 mol C/mol Nat Furthermore, the CO₂ loading of the absorption solution leaving the gas/liquid absorption unit can range from 0.75 to 1 mol C/mol Nat, or from 0.75 to 0.9 mol C/mol Nat, or from 0.75 to 0.8 mol C/mol Nat, or from 0.8 to 0.95 mol C/mol Nat

When the absorption compound is potassium carbonate, the potassium carbonate solution can have a potassium concentration ranging from 1 to 6 mol/l. In some embodiments, the potassium carbonate absorption solution can have a potassium concentration ranging from 1 to 5 mol/l, or from 1 to 4 mol/l, or from 1 to 3 mol/l, or from 1 to 2 mol/l, or from 2 to 6 mol/l, or from 2 to 5 mol/l, or from 2 to 4 mol/l, or from 2 to 3 mol/l, or from 3 to 6 mol/l, or from 3 to 5 mol/l, or from 3 to 4 mol/l, or from 4 to 6 mol/l, or from 4 to 5 mol/l, or from 5 to 6 mol/l. The CO₂ loading of the absorption solution entering the gas/liquid absorption unit can range from 0.5 to 0.75 mol C/mol K⁺, or from 0.5 to 0.7 mol C/mol K⁺, or from 0.6 to 0.7 mol C/mol K⁺. Furthermore, the CO₂ loading of the absorption solution leaving the gas/liquid absorption unit can range from 0.75 to 1 mol C/mol K⁺, or from 0.75 to 0.9 mol C/Mol K³⁰ , or from 0.75 to 0.8 mol C/mol K⁺, or from 0.8 to 0.95 mol C/mol K⁺.

In some embodiments, the pH of the absorption solution can range from 8.5 to 10.5 to be compatible with the use of the carbonic anhydrase. It has been observed that at such pH the enzyme can stay active for a long time, which can be beneficial for economic reasons.

In some embodiments, the temperature at which the CO₂-containing gas is contacted with the aqueous absorption solution can range from about 5° C. to about 70° C., or from about 20° C. to about 70° C., or from about 25° C. to about 60° C. Such temperatures are compatible with the use of the carbonic anhydrase as catalyst for the CO₂ hydration. In the case where there is no enzyme in the aqueous absorption solution, the CO₂-containing gas can be contacted with the aqueous absorption solution at higher temperatures. Therefore, when no enzyme is present in the aqueous absorption solution, the CO₂ hydration can be performed at a temperature ranging from about 5° C. to about 90° C., or from about 20° C. to about 90° C., or from about 20° C. to about 70° C., or from about 25° C. to about 60° C.

The temperature in the electrochemical conversion unit (12) can also selected to optimize the electrolysis reaction. In some embodiments, the temperature in the conversion unit (12) can vary from 20 to 90 ° C. In the case where the process involves the use of carbonic anhydrase as catalyst, and the carbonic anhydrase is not separated from the bicarbonate loaded stream before the electrochemical conversion, the temperature in the conversion unit (12) can range from about 20° C. to about 70° C. In some embodiments, the temperature in the conversion unit (12) can preferably vary from about 20° C. to about 60° C., or from about 20° C. to about 50° C., or from about 20° C. to about 40° C., or from about 20° C. to about 35° C., or from about 25° C. to about 60° C., or from about 25° C. to about 50° C., or from about 25° C. to about 40° C., or from about 30° C. to about 60° C., or from about 30° C. to about 50° C., or from about 30° C. to about 40° C.

In the case the temperature in the absorption unit (10) has to be higher or lower than the temperature of the conversion unit (12), heat exchangers can be provided to cool or heat the solution prior to its entrance in the conversion unit (12). If the process would involve the separation of the carbonic anhydrase in the separation unit (32), then the heat exchanger would preferably be positioned between the separation unit (32) and the conversion unit (12). In a similar manner, a heat exchanger could be provided to cool or heat the bicarbonate depleted solution leaving the conversion unit (12) and flowing to the absorption unit (10), as required.

As explained above, the conversion unit (12) in which the bicarbonate ions are converted into CO and H₂, comprise an electrolytic cell. The electrolytic cell can comprise a cathode compartment with a negatively charged electrode and an anode compartment with a positively charged electrode. An alkaline electrolyte solution can flow through the electrolytic cell. In some embodiments, the alkaline electrolyte solution can flow through the anode compartment and the bicarbonate loaded stream can be fed to the cathode compartment. At the cathode, the bicarbonate ions of the bicarbonate loaded stream can be converted into CO and H₂, while oxygen (O₂) is generated at the anode.

In some embodiments, the electrolytic cell can be a bipolar membrane-based electrolytic cell. For example, the anode can comprise a bipolar membrane-separated nickel gas diffusion layer and the cathode can comprise a silver-coated carbon gas diffusion layer. In some embodiments, an electrolytic cell as described in the international patent application published under number WO 2019/051609, can be used as the conversion unit. The alkaline electrolyte solution fed to the electrolytic cell can comprise an aqueous solution of KOH or NaOH. In particular embodiments, the alkaline electrolyte solution provided to the electrolytic cell can have a concentration of KOH or NaOH ranging from about 0.5 to about 10 mol/l. In some embodiments, the KOH or NaOH concentration of the alkaline electrolyte solution provided to the electrolytic cell can range from about 0.5 to about 5 mol/l, or from about 1 to about 10 mol/l, or from about 1 to about 5 mol/l, or from about 5 to about 10 mol/l. Such electrolyte solution concentrations are compatible with the conversion temperatures mentioned above, i.e. between about 20° C. to about 70° C.

In some embodiments, the electrochemical conversion of the bicarbonate ions into CO and H₂ can be conducted at a current density ranging from 20 to 200 mA.cm⁻². In other embodiments, the current density can range from 30 to 200 mA.cm⁻², or from 40 to 200 mA.cm⁻², or from 50 to 200 mA.cm⁻², or from 60 to 200 mA.cm⁻², or from 70 to 200 mA.cm⁻², or from 80 to 200 mA.cm⁻², or from 90 to 200 mA.cm⁻², or from 100 to 200 mA.cm⁻², or from 110 to 200 mA.cm⁻², or from 120 to 200 mA.cm⁻², or from 130 to 200 mA.cm⁻², or from 140 to 200 mA.cm⁻², or from 150 to 200 mA.cm⁻², or from 160 to 200 mA.cm⁻², or from 170 to 200 mA.cm⁻², or from 180 to 200 mA.cm⁻², or from 190 to 200 mA.cm⁻². In particular embodiments, the current density can range from 100 to 200 mA.cm⁻² or from 150 to 200 mA.cm⁻².

In some embodiments, the faradaic efficiency for the electrochemical conversion can be at least 50%, at least 60%, or at least 70%, or even at least 80%, relative to CO.

The present process and system can show various advantages over prior art processes and systems. In prior art processes and systems, a substantially pure CO₂ gas, i.e. a gas with a high CO₂ concentration, is required for electrolytic conversion of this CO₂ gas into syngas (mixture CO +H₂). The generation of substantially pure CO₂ from CO₂-containing gases, such as flue gases, requires complex and costly processes. Indeed, in a first step CO₂ from the flue gas must be captured and in a second step the captured CO₂ is regenerated allowing the recovery of a high concentration CO₂ gas. Only then, the high concentration CO₂ gas can be used for being converted into syngas. Advantageously, the present process and system does not require a step of regenerating CO₂ after its capture from the flue gas (or any CO₂-containing gas) and the captured CO₂, in the form of bicarbonate ions, can be directly converted into the CO+H₂ gas mixture. Therefore, the present process can allow to reduce production costs which is beneficial from an economic standpoint. The present process can also be more easily implanted as it would not require a CO₂ regeneration unit as in the prior art processes.

### EXAMPLE AND EXPERIMENTATION

Electrochemical Conversion of Bicarbonate Ions into a CO+H₂ Gas Mixture

The conversion experiments were conducted using the Berlinguette Flow Cell as described in WO 2019/051609, developed by the Berlinguette group at University of British Columbia. The experiments were conducted at a temperature of 25° C. at a voltage ranging from 3 to 3.5 V and a current density ranging from 20 to 100 mA cm⁻². The tests were performed considering two bicarbonate containing solutions. The first solution consisted in a potassium carbonate/bicarbonate aqueous solution containing 1.25 M KHCO₃, 0.91 M K₂CO₃ and deionised water (Solution 1). The second solution contained 1.25 M KHCO₃, 0.91 M K₂CO₃, deionised water and 0.5 g/l of a carbonic anhydrase (Solution 2).

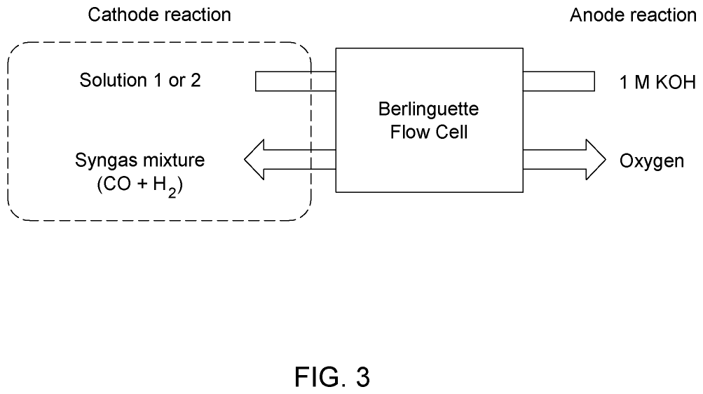

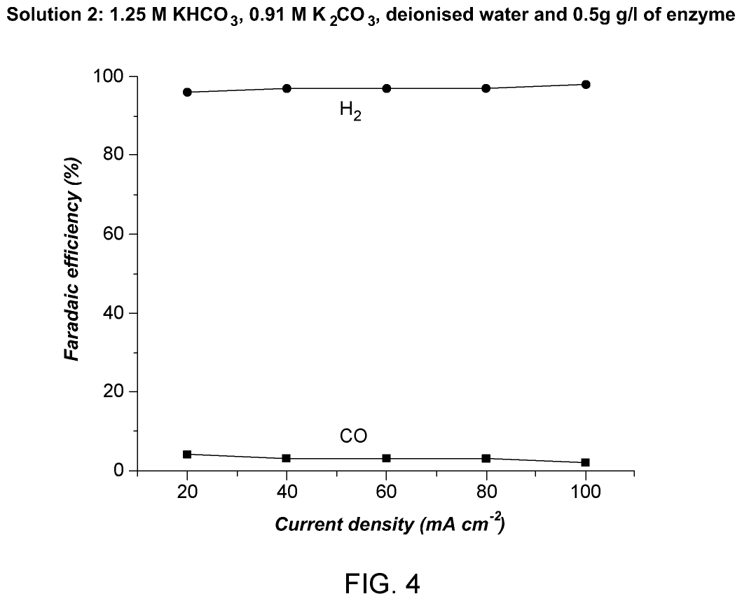

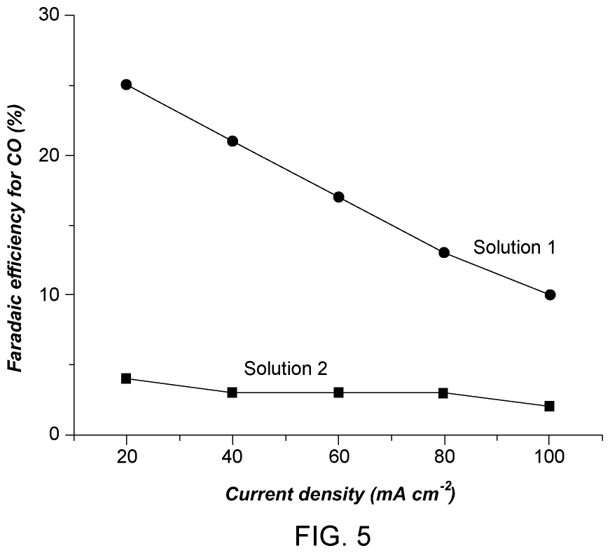

For both test conditions, the bicarbonate containing Solution 1 or 2 were fed at the cathode compartment of the Berlinguette Flow cell. An electrolyte solution of 1 M KOH in water was fed at the anode compartment. A scheme of the reactions involved at the anode and cathode electrodes of the Berlinguette Flow cell is provided in FIG. 3. For both solutions, a CO+H₂ gas mixture was produced. The composition of the output gas (i.e. CO to H₂ ratio) was measured by gas-chromatography coupled with mass spectrometry (GC-MS). The gas chromatograph (e.g. Perkin Elmer; Clarus 580 GC™) was equipped with a packed MolSieve™ 5Å column and a packed HayeSepD™ column. Argon (99.999%) was used as the carrier gas. A flame ionization detector with methanizer was used to quantify CO concentration and a thermal conductivity detector was used to quantify hydrogen concentration. Under the tests conditions, at a current density of 20 mA cm⁻², the solution without the enzyme (Solution 1) enabled the production of a gas mixture containing 25% CO and 75% H₂ and the solution containing the enzyme carbonic anhydrase (Solution 2) enabled the production of a gas mixture containing 5% CO and 95% H₂ (see FIGS. 4 and 5). One can note that by modulating the current density and/or separating the enzyme before the electrolytic conversion, one can obtain gas mixtures with different ratios of CO and H₂.

1. A process for producing carbon monoxide (CO) and dihydrogen (H₂) from a CO₂-containing gas, the process comprising:
contacting a CO₂-containing gas with an aqueous absorption solution comprising sodium or potassium bicarbonate and carbonate ions in a bicarbonate/carbonate ratio (mol/mol) ranging from 0.5 to 2 at a temperature ranging from about 5° C. to about 70° C. to produce a bicarbonate loaded stream and a CO₂-depleted gas; and
subjecting the bicarbonate loaded stream to an electrochemical conversion to generate a gaseous stream comprising CO and H₂.

2. The process of claim 1, wherein the aqueous absorption solution comprises an absorption compound selected from the group consisting of sterically hindered amines, sterically hindered alkanolamines, tertiary amines, tertiary alkanolamines, tertiary amino acids and carbonates or any mixture thereof.

3. The process of claim 1, wherein the aqueous absorption solution comprises an absorption compound selected from the group consisting of 2-amino-2-methyl-1-propanol (AMP), 2-amino-2-hydroxymethyl-1,3-propenediol (Tris), N-methyldiethanolamine (MDEA), dimethylmonoethanolamine (DMMEA), diethylmonoethanolamine (DEMEA), triisopropanolamine (TIPA), triethanolamine, N-methyl N-secondary butyl glycine, diethylglycine, dimethylglycine, potassium carbonate, sodium carbonate, cesium carbonate and any mixture thereof.

4. The process of claim 1, wherein the aqueous absorption solution comprises an absorption compound selected from the group consisting of sodium carbonate, potassium carbonate, cesium carbonate and any mixture thereof.

5. (canceled)

6. (canceled)

7. The process of claim 1, wherein the aqueous absorption solution comprises a promotor and/or a catalyst selected from the group consisting of piperazine, diethanolamine (DEA), diisopropanolamine (DIPA), methylaminopropylamine (MAPA), 3-aminopropanol (AP), 2,2-dimethyl-1,3-propanediamine (DMPDA), diglycolamine (DGA), 2-amino-2-methylpropanol (AMP), 1-amino-2-propanol (MIPA), 2-methyl-methanolamine (MMEA), piperidine (PE), arsenite, hypochlorite, sulphite, glycine, sarcosine, alanine N-secondary butyl glycine, pipecolinic acid and a carbonic anhydrase or an analogue thereof, or any mixture thereof.

8. The process of claim 1, wherein the aqueous absorption solution comprises a promotor and/or a catalyst selected from the group consisting of glycine, sarcosine, alanine N-secondary butyl glycine, pipecolinic acid and a carbonic anhydrase or an analogue thereof.

9. The process of claim 1, wherein the aqueous absorption solution comprises a promotor and/or a catalyst comprising a carbonic anhydrase or an analogue thereof.

10. (canceled)

11. The process of claim 4, wherein the carbonic anhydrase or the analogue thereof is present in the aqueous absorption solution in a concentration that is equal or less than 1% by weight of the absorption solution.

12. The process of claim 4, wherein the carbonic anhydrase or the analogue thereof is present in the aqueous absorption solution in a concentration of up to 10 g/l.

13.-15. (canceled)

16. The process of claim 4, further comprising separating the carbonic anhydrase or the analogue thereof from the bicarbonate loaded stream before subjecting the bicarbonate loaded stream to the electrochemical conversion to generate CO and H₂.

17. The process of claim 16, further comprising recycling the carbonic anhydrase or the analogue thereof to the aqueous absorption solution.

18. The process of claim 1, wherein the aqueous absorption solution comprises sodium carbonate and a concentration in sodium in the absorption solution ranges from 0.5 to 2 mol/l.

19. The process of claim 1, wherein the aqueous absorption solution comprises potassium carbonate and a concentration in potassium in the absorption solution ranges from 1 to 6 mol/l.

20. The process of claim 1, wherein the aqueous absorption solution comprises potassium carbonate and potassium bicarbonate, and a CO₂ loading in the absorption solution, before contacting the CO₂-containing gas, ranges from 0.5 to 0.75 mol C/mol K⁺.

21. The process of claim 1, wherein the bicarbonate loaded stream comprises potassium bicarbonate and potassium carbonate, and a CO₂ loading in the bicarbonate loaded stream, after contacting the CO₂-containing gas, ranges from 0.75 to 1 mol C/mol K⁺.

22. The process of claim 1, wherein the aqueous absorption solution comprises a carbonic anhydrase or the analogue thereof, and a pH of the aqueous absorption solution ranges from 8.5 to 10.5.

23. (canceled)

24. The process of claim 1, wherein the CO₂-containing gas is contacted with the aqueous absorption solution comprising a carbonic anhydrase or an analogue thereof as catalyst, at a temperature ranging from about 5° C. to about 70° C.

25. The process of claim 1, wherein the electrochemical conversion comprises converting bicarbonate ions of the bicarbonate loaded stream into the gaseous stream comprising CO and H₂ in an electrolytic cell provided with an alkaline electrolyte solution and generating a bicarbonate depleted stream.

26. The process of claim 25, wherein the bicarbonate depleted stream is recycled to the aqueous absorption solution for contacting with the CO₂-containing gas.

27. (canceled)

28. (canceled)

29. The process of claim 24, wherein the alkaline electrolyte solution comprises an aqueous solution of KOH or NaOH.

30. (canceled)

31. The process of claim 1, wherein the electrochemical conversion is conducted at a temperature ranging from 20 to 70 ° C.

32. The process of claim 1, wherein the electrochemical conversion is conducted at a current density ranging from 20 to 200 mA.cnr².

33. (canceled)

34. (canceled)

35. A system for producing carbon monoxide (CO) and dihydrogen (H₂) from a CO₂-containing gas, the system comprising:
an absorption unit for contacting a CO₂-containing gas with an aqueous absorption solution to produce a bicarbonate loaded stream and a CO₂-depleted gas; and
a conversion unit comprising an electrolytic cell for electrochemically converting bicarbonate ions in the bicarbonate loaded stream to generate a gaseous stream comprising CO and H₂ and a bicarbonate depleted stream.

36.-48. (canceled)

49. The system of claim 35, wherein the carbonic anhydrase or the analogue thereof is present in the aqueous absorption solution in a concentration ranging from 0.15 to 0.3 g/l.

50. The system of claim 35, further comprising a separating unit downstream the absorption unit and upstream the conversion unit to separate the carbonic anhydrase or the analogue thereof from the bicarbonate loaded stream.

51. The system of claim 49, further comprising an enzyme recycling line for returning the separated carbonic anhydrase or the analogue thereof to the absorption unit.

52.-56. (canceled)

57. The system of claim 35, wherein the absorption unit comprises a packed column, a spray absorber, a fluidized bed or a high intensity contactor, including a rotating packed bed.

58.-66. (canceled)
